(19) United States
(12) Patent Application Publication
(10) Pub. No.: US 2008/0263476 A1
(43) Pub. Date: Oct. 23, 2008

(54) Playlist Based on Artist and Song Similarity

(75) Inventors: Fabio Vignoli, Veldhoven (NL); Steffen Clarence Pauws, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,274

(22) PCT Filed: Jan. 20, 2005
(86) PCT No.: PCT/IB2005/050183

§ 371 Date: Jul. 19, 2006

Related U.S. Application Data
(60) Provisional application No. 60/537,799, filed on Jan. 20, 2004.

(51) Int. Cl. G06F 3/048

(52) U.S. Cl. 715/810

(57) ABSTRACT

A playlist generator allows a user to identify a particular artist as the seed for a one-click playlist generation. When the user identifies the artist, a list of similar artists is presented for the user's approval or modification. When the user is satisfied with the list of artists, the user initiates the playlist generation. The system iteratively selects an artist from the list, and selects a song by that artist, based on the similarity of songs by the artist. The user may control the degree of variety among artists and among songs.

This invention relates to the field of entertainment systems, and in particular to a playlist generator that provides a playlist from selections contained within a collection of material based on similarity among artists and songs.

Playlists define a subset of identifiers of entertainment selections, such as songs, videos, multimedia segments, and so on, for subsequent rendering via a corresponding rendering device or system.

A playlist generator facilitates the creation of a playlist. Conventionally, a playlist generator receives a set of user preferences, and applies this set of preferences to a collection of material to identify selections in the collection that satisfy the set of preferences. To create a different playlist, a user modifies the preferences and submits this modified set of preferences to the playlist generator.

For ease of reference, the phrase “the playlist includes an item”, or similar phrases, is hereinafter understood to mean that the playlist includes an identifier of the item, from which a rendering device can access the recorded item for the rendering of its content. Also for ease of reference, the invention is presented in the context of a playlist generator that creates a playlist of songs. One of ordinary skill in the art will recognize that the principles presented herein are independent of the type of material being playlisted.

Typically, playlist generation is an iterative process, wherein a user iteratively refines the criteria contained in the set of user preferences that are used to generate the playlist. Often, during this process, the user may enter conflicting and/or non-coherent criteria, and the resultant playlist is not satisfactory to the user, requiring further iterations and/or a restart of the entire process.

“One-click” playlists ease the task of specifying the user's preferences for a particular playlist. Such one-click playlists allow a user to select a button marked “dinner-music”, “romantic-music”, “classic rock-and-roll”, “current hits”, etc. to generate a corresponding playlist matching a set of predefined criteria associated with the selected button. Generally, these predefined criteria are provided with the playlist generator system, and have been developed with an insight into the algorithms used by the playlist generator, thereby increasing the likelihood of a coherent playlist that conforms to the corresponding one-click button identifier.

Although one-click playlist generators ease the task of specifying a user's preferences, the resultant playlist will only be satisfactory to the user if the user's current preferences happen to coincide with one of the sets of predefined criteria corresponding to one of the one-click buttons.

It is an object of this invention to provide a playlist generator that allows for user interaction while also providing the ease and simplicity of a one-click playlist generator. It is a further object of this invention to facilitate playlist generation based on artist and song similarities.

These objects and others are achieved by a playlist generator that allows a user to identify a particular artist as the seed for a one-click playlist generation. When the user identifies the artist, a list of similar artists is presented for the user's approval or modification. When the user is satisfied with the list of artists, the user initiates the playlist generation. The system iteratively selects an artist from the list, and selects a song by that artist, based on the similarity of songs by the artist. The user may control the degree of variety among artists and among songs.

Following are descriptions of illustrative embodiments of the present invention that, when taken in conjunction with the drawing will demonstrate the above noted features and advantages, as well as other features and advantages.

The drawing is included for illustrative purposes and is not intended to limit the scope of the invention. In the drawing:

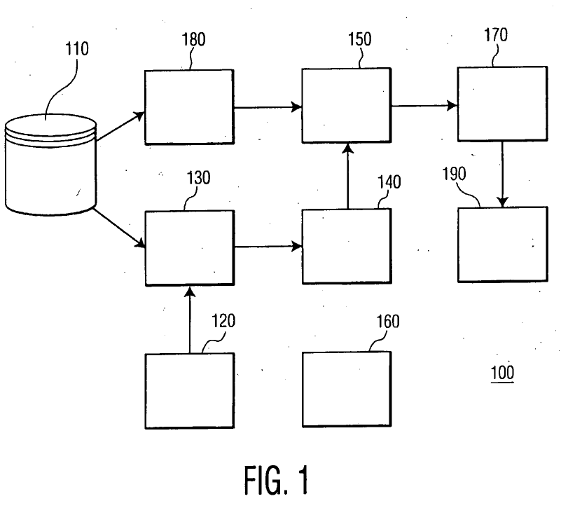

FIG. 1 illustrates an example block diagram of a playlist generation system in accordance with this invention.

FIG. 1 illustrates a system 100 that includes a user interface 120 that is coupled to an artist similarity module 130. The user identifies an artist via the interface 120, and the similarity module 130 presents a list of similar artists found in a source 110 of content material. The source 110 may be the user's collection of songs, or it may include songs that are available for downloading from other sites, via, for example, the Internet, or any combination thereof. Via the interface 120, the user is provided the option of deleting particular artists from the list, selecting a different artist as the selected artist, and so on, until an acceptable list of similar artists is obtained.

Copending PCT application Ser. No. ______, “______”, filed ______ for Fabio Vignoli, Attorney Docket ______ (Disclosure 614510), and incorporated by reference herein, teaches a system for identifying similar artists, based on a “distance measure” that is determined by such factors as the genre or style of the artists, the tempo or mood of the songs performed by the artist, the artists' active time periods, the strength or beat of the songs, and so on. Of particular note, this copending application teaches the determination of similarity among artists whose songs are available at the current source 110, so that the list of artists that is presented by the similarity module 130 is appropriate for the task of generating a playlist of material from the source 110.

Via the user interface 120, the user may specify a degree of similarity desired among the artists selected by the similarity module 130. If a high degree of similarity is desired, only closely-matching artists will be listed; if a lower degree of similarity is acceptable, distantly-matching artists will also be included in the list. In an embodiment that includes the determination of the aforementioned distance measure, for example, the user's desired level of similarity will control a threshold level so that artists with distances from the selected artist that are below the threshold level are included in the list, and those above the threshold level are excluded from the list. Also via the user interface 120, the user can also identify the type of similarity, or combination of types; for example, the similarity may be based on chronology, theme, tone, style, and so on.

Although the term “list” is used herein for ease of understanding, one of ordinary skill in the art will recognize that any of a variety of schemes may be used to present similar artists to the user. For example, the selected artist may be presented in the center of a display screen, and similar artists displayed on the screen at distances from the center based on the degree of similarity to the selected artist. In this embodiment, the user may indicate the desired level of similarity by drawing a circle that encompasses the desired range of similarity distances.

The user initiates the one-click generation of a playlist when he/she is satisfied with the list of similar artist. At this point, a controller 160 initiates an iterative artist-song selection process, via the artist selector 140 and song selector 150, to create a playlist 170. Depending upon the intended use of the playlist 170, the controller 160 may be configured to select a fixed number of songs for inclusion in the playlist 170, or to select songs until a fixed play-time duration is reached, or until another stopping criteria is reached.

The artist selector 140 selects an artist from the list provided by the similarity module 130 using any of a variety of selection criteria. The selection process may range from an ordered selection of artists from the list to a purely random selection, or a mix of order and randomness. The similarity measure may be used to assign a probability factor to each artist, and this probability factor can be used to affect the likelihood of each artist being selected by the selector 140. Additionally, the user's desired level of variety can be used to bias these probability factors to effect a broader or narrower diversity in the selection process. That is, for example, in addition to setting a distance-threshold level to include distantly-similar artists, as discussed above, the user is able to affect the number of songs from distantly-similar artists that are included in the playlist 170 via such a diversity-setting criteria. If the diversity setting is high, the probability distribution function (pdf) will be relatively flat, whereas if the diversity setting is low, the probability distribution function will be peaked for closely-similar artists, and substantially lower for distantly-similar artists. These and other methods of selecting from a list of similar artists will be evident to one of ordinary skill in the art in view of this disclosure.

Having selected an artist, the controller 160 enables the song selector 150 to select a particular song by the selected artist. This song selection process is facilitated by a cluster module 180 that is configured to preprocess songs from the source 110 to identify clusters of similar songs within the source 110. Clustering is a process that is common in the art for grouping items having similar characteristics. Each item in a collection is associated with a corresponding point in an N-dimensional space. In a collection of songs, the attributes of each song, such as its genre, style, beat, strength, and so on, determines its corresponding point in the N-dimensional space. The N-dimensional space is partitioned into clusters, based on the distribution of items in the N-dimensional space, and the “center of gravity” of each cluster is determined. Each item is a member of the cluster whose center of gravity is closest to the item.

The clustering of similar songs can be used in a variety of ways to facilitate the selection of a song by the selected artist. A cluster-histogram of all of the songs of the selected artist can be created to identify the types of songs performed by this artist. If the artist is very diverse, the cluster-histogram will typically indicate proportions of songs by this artist in multiple clusters; if the artist has a very prominent style, the cluster-histogram will typically indicate a high proportion of songs by this artist in a single cluster.

The user is provided the option of indicating a diversity level for the selection of songs by the song selector 150. If the user selects a high song-diversity level, the song selector 150 selects from among any of the clusters indicated by the cluster-histogram of this artist; if the user selects a low song-diversity level, the song selector 150 selects from the most predominant cluster indicated by the cluster-histogram of this artist. Other selection techniques may also be used. For example, the system can be configured to allow the user to select a ‘surprise’ option, wherein the selector 150 purposely selects songs from the least popular clusters of the selected artist. Alternatively, the user can identify a set of preferred song clusters at the start of the playlist generation process, and the selector 150 would be configured to preferably select songs from these clusters, if the selected artist has any songs in these clusters. These and other methods of selecting songs of a given artist will be evident to one of ordinary skill in the art in view of this disclosure.

As noted above, the controller 160 iterates through the artist-selection song-selection process described above to select songs for inclusion in the playlist 170 until the desired number of songs, or the desired play-time duration, or other criteria, is achieved. Optionally, the playlist generator 100 may also include a rendering device 190 for rendering the material identified in the playlist 170, or the playlist 170 may be provided to a separate rendering system.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the artist and song selection process described herein may be combined with other playlist generation techniques. The list of artists, for example, may originally be provided by filtering the source 110 based on a set of user preferences for the particular playlist, and the subsequent lists of similar artists may also be influenced by these user preferences. If a particular artist, for example, is popular as both a country-western and a rock-and-roll singer, and the user's current preference is set to country-western, the list of similar artists would be configured to only include similar country-western artists. In like manner, if the source 110 is a family collection, a particular family member may have a set of global ‘tastes’ that serve to filter the source 110 to form a subset of the material from the source 110 from which the system 100 selects artists and songs to generate the playlist for this family member. These and other system configuration and optimization features will be evident to one of ordinary skill in the art in view of this disclosure, and are included within the scope of the following claims.

1. A system comprising:
a playlist generator that is configured to create a playlist, and includes:
an artist similarity module that is configured to identify one or more similar artists to an identified artist to create an artist list,
an artist selector, operably coupled to the artist similarity module, that is configured to select a selected artist from the artist list, and
an item selector, operably coupled to the artist selector, that is configured to:
select a selected item associated with the selected artist from a source of items, and
include an identifier of the selected item in the playlist.

2. The system of claim 1, wherein
the artist similarity module is further configured to identify the one or more similar artists based on a plurality of artists associated with the source of items.

3. The system of claim 1, further including
a collection of items of a user that correspond to the source of items.

4. The system of claim 1, further including
a rendering device that is configured to render items identified in the playlist.

5. The system of claim 1, wherein
the system is further configured to create a subset of source items from the source of items, based on one or more general preferences of the user, and
the playlist generator is further configured to limit the selected item to the subset of source items.

6. The system of claim 1, wherein
one or more items of the source of items are accessible via an Internet access.

7. The system of claim 1, further including
a user interface that facilitates identification of the identified artist.

8. The system of claim 1, further including
a user interface that facilitates selection of a level of artist similarity, and
wherein
the artist similarity module is configured to identify the one or more similar artists based on the selected level of artist similarity.

9. The system of claim 1, further including
a user interface that facilitates selection of a level of artist diversity, and
wherein
the artist selector is configured to select the selected artist based on the selected level of artist diversity.

10. The system of claim 1, further including
a user interface that facilitates selection of a level of item diversity, and
wherein
the item selector is configured to select the selected item based on the selected level of item diversity.

11. The system of claim 1, further including
an item cluster module that is configured to partition each item associated with the selected artist in the source of items into one or more clusters, based on attributes associated with each item, and
wherein
the item selector is further configured to select the selected item based on the cluster of the one or more clusters associated with the selected item.

12. The system of claim 1, wherein
the item selector is further configured to select the selected item based on whether the selected item is similar to other items associated with the selected artist.

13. A method of generating a playlist, comprising:
identifying an identified artist,
identifying one or more similar artists to the identified artist,
selecting a select artist from the one or more similar artists,
selecting a select item associated with the select artist,
including an identifier of the select item in the playlist.

14. The method of claim 13, wherein
selecting the selected artist includes
selecting the selected artist from a plurality of artists associated with the source of items, and
selecting the selected item includes
selecting the selected item from a plurality of items in the source of items.

15. The method of claim 13, further including
identifying a subset of source items from a source of items, based on one or more preferences of a user, and
wherein
selecting the selected item includes
selecting the selected item from the subset of source items.

16. The method of claim 13, further including
identifying a selected level of artist similarity, and
wherein
selecting the selected artist is based on the selected level of artist similarity.

17. The method of claim 13, further including
identifying a selected level of artist diversity, and
wherein
selecting the selected artist is based on the selected level of artist diversity.

18. The method of claim 13, further including
identifying a selected level of item diversity, and
wherein
selecting the selected item is based on the selected level of item diversity.

19. The method of claim 13, further including
clustering each item associated with the selected artist into one or more clusters, and
wherein
selecting the selected item is based on the cluster of the one or more clusters associated with the selected item.

20. The method of claim 13, wherein
selecting the selected item includes
determining a similarity of the selected item to other items associated with the selected artist, and
selecting the selected item based on the similarity.
